(19) United States
(12) Patent Application Publication
(10) Pub. No.: US 2025/0023628 A1
(43) Pub. Date: Jan. 16, 2025

(54) TECHNIQUES FOR DATA ROUTING BETWEEN SATELLITES AND GROUND-BASED SERVERS

(71) Applicant: Viasat Inc., Carlsbad, CA (US)

(72) Inventors: David J. HANCHARIK, Norcross, GA (US); Meredith L. Caligiuri, San Diego, CA (US)

(21) Appl. No.: 18/711,308

(22) PCT Filed: Nov. 18, 2022
(86) PCT No.: PCT/US2022/050384

§ 371 Date: May 17, 2024

Related U.S. Application Data
(60) Provisional application No. 63/281,466, filed on Nov. 19, 2021.

(51) Int. Cl. H04B 7/185

(52) U.S. Cl. CPC H04B 7/18513; H04B 7/18519

(57) ABSTRACT

Methods, systems, and devices for data routing between satellites and ground based servers are described. A terminal of a satellite may receive a data packet associated with a latency metric from a payload of the satellite. The terminal may determine whether the latency metric is less than a threshold based on a first duration associated with the first satellite being in range of a ground station of a plurality of ground stations. If the terminal determines that the latency metric is less than the threshold, the terminal may queue the data packet for transmission via a first data path which includes an indirect link via a second satellite to a ground-based server. Alternatively, if the terminal determines that the latency metric is greater than the threshold, the terminal may queue the data packet for transmission via a second data path which includes a direct link to the ground-based server.

### CROSS REFERENCE

The present application is a 371 national phase filing of International Patent Application No. PCT/US2022/050384 by HANCHARIK et al. entitled, “TECHNIQUES FOR DATA ROUTING BETWEEN SATELLITES AND GROUND-BASED SERVERS”, filed Nov. 18, 2022, and to U.S. Provisional Patent Application No. 63/281,466 by HANCHARIK et al., entitled “LEO POLICY ROUTING” filed Nov. 19, 2021, each of which are assigned to the assignee hereof and each of which is hereby incorporated by reference in its entirety.

### BACKGROUND

The following relates generally to communications, including techniques for data routing between satellites and ground-based servers.

Communications devices may communicate with one another using wired connections, wireless (e.g., radio frequency (RF)) connections, or both. Wireless communications between devices may be performed using a wireless spectrum that has been designated for a service provider, wireless technology, or both. In some examples, the amount of information that can be communicated via a wireless communications network is based on an amount of wireless spectrum designated to the service provider, and an amount of frequency reuse within the region in which service is provided. Satellites may be employed for various functions and may be in various orbits, some of which may not continuously be in range of ground stations. Thus, getting data to the ground from satellites may present challenges.

### SUMMARY

The described techniques relate to improved methods, systems, devices, and apparatuses that support techniques for data routing between satellites and ground-based servers. A satellite (e.g., a low-earth orbit (LEO) satellite, or a medium-earth orbit (MEO) satellite) may include a terminal for communications with ground stations. In some cases, the terminal may be configured to communicate directly with any one of multiple available ground stations. However, the satellite may not be within range of the ground stations throughout its orbit given an orbital path across the Earth as the Earth rotates. The terminal may receive a data packet from a payload of the satellite. The data packet may include metadata indicating a latency metric associated with the data packet and a quality of service (QOS) metric associated with the data packet. The terminal may determine whether the latency metric is less than a duration associated with the satellite being in range of a ground station of the multiple available ground stations. If the terminal determines that the latency metric is less than the duration, the terminal may queue the data packet for transmission via a first data path which includes an indirect link via a second satellite (e.g., a geosynchronous orbit (GEO) satellite) to a ground-based server. Alternatively, if the terminal determines that the latency metric is greater than the duration, the terminal may queue the data packet for transmission via a second data path which includes a direct link to the ground station (e.g., ground-based server).

### BRIEF DESCRIPTION OF THE DRAWINGS

FIG. 1 shows an example of a satellite communication system that supports techniques for data routing between satellites and ground-based servers in accordance with examples described herein.

FIG. 2 illustrates an example of a system that supports techniques for data routing between satellites and ground-based servers in accordance with aspects of the present disclosure.

FIG. 3 illustrates an example of a process flow that supports techniques for data routing between satellites and ground-based servers in accordance with aspects of the present disclosure.

FIG. 4 illustrates a block diagram of that supports techniques for data routing between satellites and ground-based servers in accordance with aspects of the present disclosure.

FIGS. 5 through 6 illustrate flowcharts showing methods that support techniques for data routing between satellites and ground-based servers in accordance with aspects of the present disclosure.

### DETAILED DESCRIPTION

In some examples, a satellite, such as a low-earth orbit (LEO) satellite, or a medium-earth orbit (MEO) satellite, may store, gather, or relay user data. The satellite may transmit the user data to a ground-based server in accordance with a latency time (e.g., a duration of time between the satellite receiving the data and the satellite transmitting the data to the ground based server). In some examples the satellite may transmit the data via a direct link to an access node associated with the ground-based server. The access node may be one of one or more available ground stations for the satellite. Alternatively, the satellite may transmit the data via an indirect link, such as by transmitting the data to a second satellite (e.g., a geostationary orbit (GEO) satellite), which may in turn transmit the data to the ground-based server. Because a direct communication link between the satellite and particular access node may be relatively uncongested (e.g., relative to an indirect link with a GEO satellite), transmitting data via the direct link may be less expensive (e.g., use relatively less valuable communication resources) than transmitting the data via the indirect link. However, because the satellite may move relative to access nodes, the satellite may undergo periods in which the satellite may not be able to transmit the data via a direct link, which may increase the latency of transmitting that data. Accordingly, techniques to determine a data path for transmitting data to a ground-based server are desired.

As described herein, a terminal (e.g., a router) of a satellite may determine to transmit data via a first data path or a second data path. For example, the terminal of the satellite may receive a data packet from a payload of the satellite. The data packet may include metadata indicating a latency metric associated with the data packet and a quality of service (QOS) metric associated with the data packet. The terminal may determine whether the latency metric is less than a duration associated with the satellite being in range of a ground station of the one or more available ground stations. If the terminal determines that the latency metric is less than the duration, the terminal may queue the data packet for transmission via a first data path which includes an indirect link via a second satellite (e.g., a GEO satellite) to a ground-based server. Alternatively, if the terminal determines that the latency metric is greater than the duration, the terminal may queue the data packet for transmission via a second data path which includes a direct link to the ground-based server.

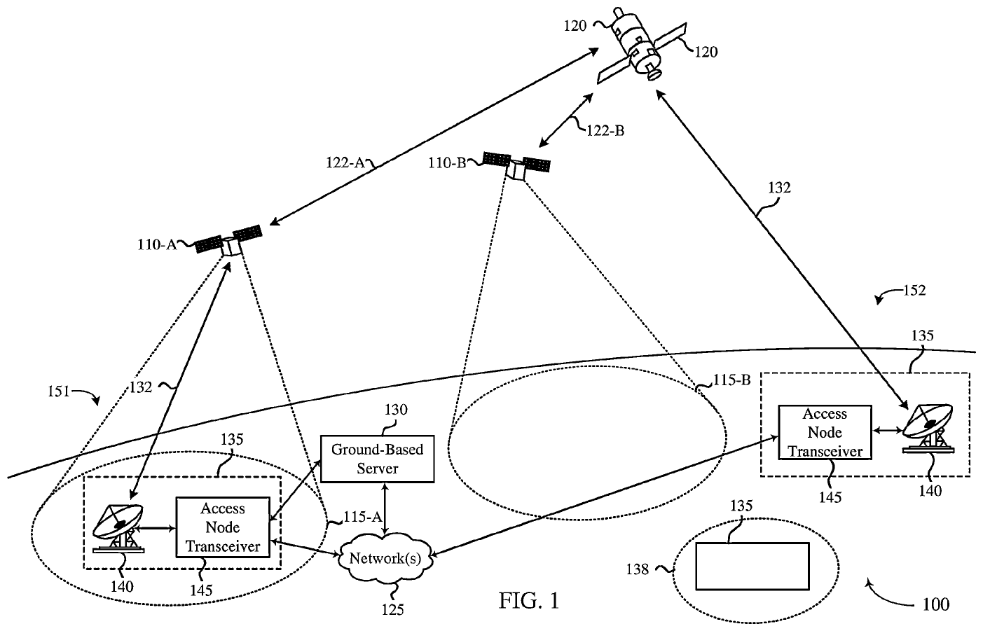

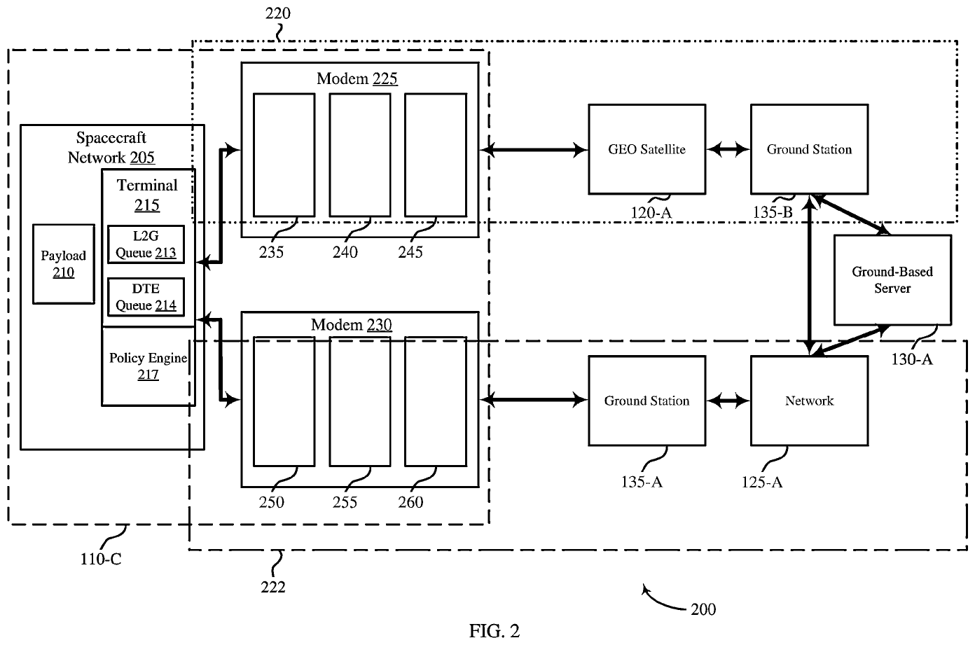

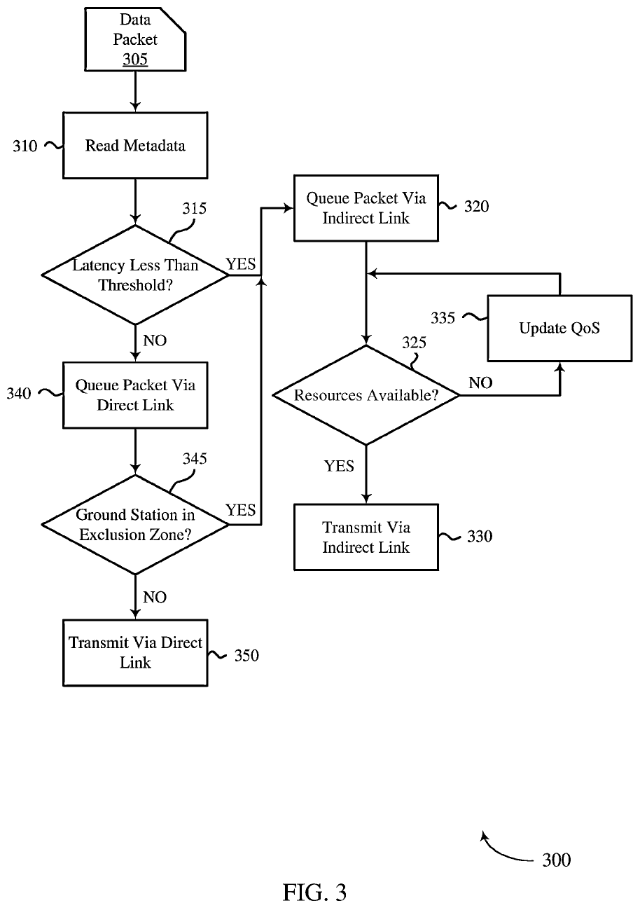

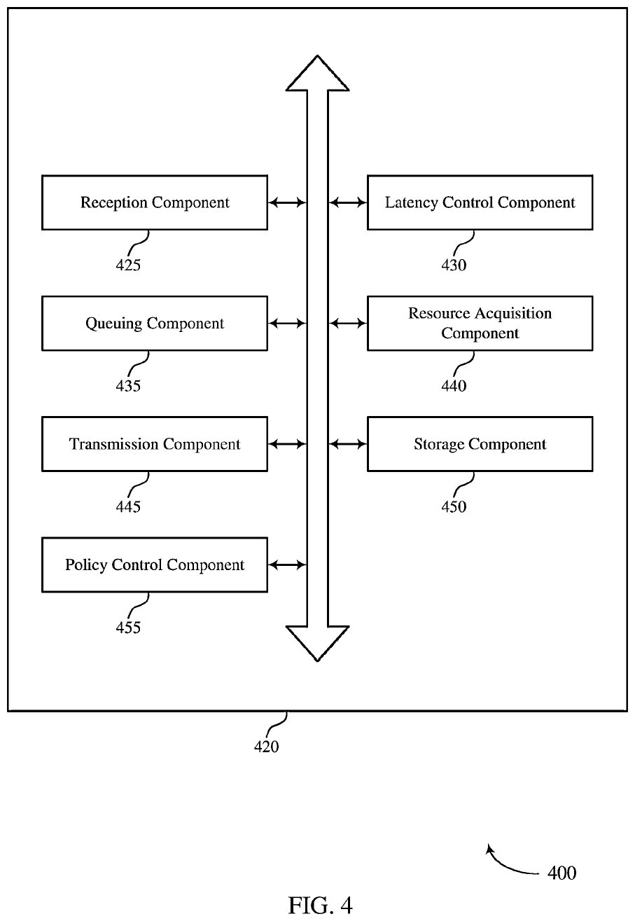

Aspects of the disclosure are initially described in the context of satellite communication systems with reference to FIG. 1. Aspects of the disclosure are further described in the context of a system and a process flow in reference to FIGS. 2 and 3. Aspects of the disclosure are further illustrated by and described with reference to a block diagram and flowcharts that relate to techniques for data routing between satellites and ground-based servers with reference to FIGS. 4 through 6.

FIG. 1 shows an example of a satellite communication system 100 that supports techniques for data routing between satellites and ground-based servers in accordance with examples described herein. The satellite communication system 100 may include a first network 151 of ground stations 135 configured to communicated with one or more LEO satellites 110 (e.g., or MEO satellites 110) and a second network 152 of ground stations 135 configured to communicate with one or more GEO satellites 120. In some cases, some ground stations 135 may be shared between the first network 151 and the second network 152.

The LEO satellites 110 may relay communication signals to a GEO satellite 120 using respective communication links 122 (e.g., the LEO satellite 110-a may communicate with the GEO satellite 120 via the communication link 122-a, and the LEO satellite 110-b may communicate with the GEO satellite 120 via the communication link 122-b). The LEO satellites 110, GEO satellites 120, or both may be equipped with multiple antennas (e.g., one or more antenna feeds or antenna arrays). Additionally, the LEO satellites 110, GEO satellites 120, or both, may transmit communication signals to the ground stations 135, for example to transfer data or other digital information stored on the LEO satellites 110, GEO satellites 120, or both.

A ground station 135 may include one or more access nodes 140 which are configured to communicate with a satellite, such as a LEO satellite 110 or a GEO satellite 120 via a communication link 132. The access nodes 140 may be coupled with access node transceivers 145 that are configured to process signals received from and to be transmitted through corresponding access node(s) 140. The access node transceivers 145 may also be configured to interface with a network 125 (e.g., the Internet) e.g., via a ground-based server 130 (e.g., a network device, a network operations center, satellite and gateway terminal command centers, or other central processing centers or devices) that may provide an interface for communicating with the network 125. The ground station 135 may also contain access nodes 140 with multiple antennas or antenna array elements.

In some examples, the access node transceiver 145 may process the communication signals received at the access nodes 140—e.g., may downconvert, demodulate, and decode the communication signals. The access node transceiver 145 may also process the communication signals to be transmitted from the access nodes 140—e.g., may upconvert, encode, and modulate the communication signals.

The LEO satellites 110 may include multiple components installed on a chassis, such as sensing components, processing components, or communication components. The chassis may include structural components as well as power systems for the other components (e.g., solar arrays, batteries), on-board communication (e.g., a communication bus), and station-keeping components (e.g., thrusters). The communication components may include a terminal, such as a router, configured to support transmitting data to a ground station 135 using antennas and radiofrequency (RF) devices onboard the LEO satellite 110. The LEO satellite may be operated by a user for purposes associated with the payload functions (e.g., communications, sensing). For example, the LEO satellites 110 may receive, collect, and store data, such as sensor data gathered by a LEO satellite 110, user data (e.g., communication data) of an entity operating a payload of a LEO satellite, data received from other satellites, or other forms of data. The data may be organized into one or more data packets, which may each include a portion of the data. In some cases, a data packet may additionally include a header, which may store metadata associated with the data of the data packet. In some cases, a data packet stored on a LEO satellite may have a latency associated with delivery. For example, a user of a payload of a LEO satellite 110 may enter into a service license agreement (SLA) with a satellite system operator for transfer of data (e.g., data packets) from the satellite to a ground server. The satellite system operator may supply components of the LEO satellite for communication of the data to ground stations. The SLA may be associated with a policy for transfer of the data according to various metrics for service, such as data volume, data latency, or data type. For example, the policy may indicate a latency associated with delivery (e.g., maximum latency) for data packets to be transferred to a ground-based server 130. The terminal may manage the data packets according to the policy to transmit the data packets to the ground station 135, for example transmitting the data packets in accordance with the latency associated with delivery of the data packets.

For example, if the LEO satellite is within range of a ground station 135 (e.g., if the ground station 135 is within the coverage area 115-a of the LEO satellite 110-a or the coverage area 115-b of the LEO satellite 110-b), the terminal may, in some cases, schedule the data packet for transmission to the ground station 135 using a direct communication link 132 (e.g., a communication link 132 which is not intercepted and forwarded by a separate entity between the LEO satellite 110 and the ground station 135). In some examples, such a data path may be referred to as a direct-to-earth (DTE) path, and the associated ground station 135 may be referred to as a DTE site.

In some examples, the coverage areas 115 of individual LEO satellites 110 may change over time. For example, as the LEO satellite 110-a moves over the surface of the earth, the corresponding coverage area 115-a may also move along with the LEO satellite 110-a. Accordingly, an individual LEO satellite 110 may move within or out of range of a ground station 135. For example, some LEO satellites 110 may execute polar orbits, in which the LEO satellite passes over the northern and southern poles of the earth in each orbit, but may pass over different regions of the earth between the poles in each orbit. Thus, such LEO satellites 110 may not reliably be in range of ground stations between the northern and southern poles. In some cases, a terminal of the LEO satellite 110 may access data indicating the location of the LEO satellite 110, as well as locations of each of a network of ground stations 135. Using the location data, the terminal may determine a predicted time period during which the LEO satellite 110 will be in range of a ground station 135. In some examples, if the duration until the time period is less than the latency associated with delivery of a data packet, the terminal may queue the data packet for transmission using the DTE link during the time period.

Alternatively, if the duration until the time period is greater than the latency associated with delivery of a data packet, the terminal may schedule the data packet for transmission using an indirect link. For example, the terminal may schedule the data packet for transmission to a GEO satellite 120 over a communication link 122. Upon receiving the data packet, the GEO satellite 120 may retransmit the data packet to a ground station 135 of the second network 152 using a communication link 132. In some cases, such a data path may be referred to as a LEO to GEO (L2G) path. The ground station 135 may route the data packet to a ground-based server 130, for example via the network 125.

In some cases, a ground station 135 may be within an exclusion zone 138. As described herein, an exclusion zone 138 for a data packet may be indicated by the policy associated with the data packet. Additionally or alternatively, the exclusion zone 138 may be indicated within the metadata (e.g., the header) of the data packet. An exclusion zone 138 may be sensor specific, location specific, etc., and may refer to an area or territory (e.g., a country, a non-secure location) in which transmitting data may be insecure or undesirable. If the terminal determines that a ground station 135 is within an exclusion zone (e.g., and that the delay to the next ground station outside the exclusion zone exceeds the latency metric), the terminal may refrain from transmitting the data packet to the ground station 135, and may instead transmit the data packet using an alternate route, such as an indirect link.

FIG. 2 shows an example of a system 200 for a satellite communication system that support techniques for data routing between satellites and ground-based servers in accordance with examples described herein. The system 200 may include a satellite 110-c, which may be an example of a LEO satellite 110 as described with reference to FIG. 1, which may communicate with a ground-based server 130-a using a GEO satellite 120-a, a ground station 135-a, or both. For example, the satellite 110-c may include an L2G modem 225 configured to transmit data to the GEO satellite 120-a, which may forward the data to the ground-based server 130-a via the ground station 135-b. Additionally, the satellite 110-c may include a DTE modem 230 configured to transmit data to a ground station 135-a, which may forward the data to the ground-based server 130-a, for example via a network 125-a.

The satellite 110-a may include a spacecraft network 205. The spacecraft network 205 may be an example of a local area network (LAN), and may support communication between components of the satellite 110-c. For example, the spacecraft network 205 may support communication of one or more data packets of a payload 210 (e.g., user data, one or more portions of the payload 210) stored in a memory of the satellite 110-c to a terminal 215 of the spacecraft network 205.

The terminal 215 may be an example of a router, such as a smart router, which may manage a data path of a data packet between the satellite 110-c and a ground-based server 130-a in accordance with a policy associated with the data packet. For example, the terminal 215 may determine to route the data packet to the ground-based server 130-a via a first data path 220 or a second data path 222, based on metadata of the data packet. In some cases, the terminal 215 may include or may be in communication with a policy engine 217, which may store and manage one or more policies associated with users and data packets corresponding to (e.g., owned by) the users. The policy engine 217 may support configuring metadata of a data packet, such as providing a latency metric (e.g., a latency associated with delivery, as described with reference to FIG. 1), a quality of service (QOS) metric, or both to the metadata. In some cases, the terminal 215 may include a controller coupled with a memory device to support performing various functions, such as managing the data path, as described herein.

The first data path 220 may include an indirect link to the ground-based server 130-a. For example, if the terminal 215 determines to transmit the data packet via the first data path 220, the terminal 215 may store the data packet in a queue 213 associated with the L2G modem 225. The terminal 215 may transmit an indication to the L2G modem 225 that the data packet has been queued, along with a the QoS associated with the data packet. In some cases, the indication may include a request for resources (e.g., communication resources, one or more time-frequency resources) from the L2G modem 225, for example using the QoS metric included in the metadata of the data.

The L2G modem 225 may process the request, for example using a network processing component 235, to determine, using the QoS metric, whether resources for the data packet are available. If the L2G modem 225 determines that resources are available for the data packet, the L2G modem 225 may schedule and transmit the data packet to the GEO satellite 120-a.

In some cases, upon receiving the request for resources and associated QoS metric, the L2G modem 225 may determine that resources corresponding to the QoS metric are not available. In such cases, the L2G modem 225 may deny the request (e.g., may leave the data packet in the queue for one or more time periods associated with the resources used for transmission from the modem 225). In response, the terminal 215 may store the data packet for a duration of time, and may submit a second request for resources after the duration (e.g., or the first request may remain pending). Additionally or alternatively, the terminal 215 may, in accordance with a policy associated with the data packet, update (e.g., increase) the QoS metric of the data packet, and may submit a second request for resources to the L2G modem 225 using the updated QoS metric.

The L2G modem 225 may transmit the data packet to the GEO satellite 120-a, for example using an RF component 240, an antenna unit 245, or both. The GEO satellite 120-a may receive and retransmit the data packet to a ground station 135-b, which may in turn relay the data packet to the ground-based server 130-a, for example via a network 125-a or via a separate connection to the ground-based server 130-a.

The second data path 222 may include a direct link to the ground-based server 130-a. For example, if the terminal 215 determines to transmit the data packet via the second data path 222, the terminal 215 may store the data packet in a queue 214 associated with the DTE modem 230. The terminal 215 may transmit an indication to the DTE modem 230 that the data packet has been queued. In some cases, the indication may include a request for resources (e.g., communication resources, one or more time-frequency resources) from the DTE modem 230. In some cases, the indication that the data packet has been queued may include an indication of the QoS associated with the data packet.

The DTE modem 230 may process the request, for example using a network processing component 250, to determine whether resources for the data packet are available. In some cases, processing the request may be performed according to the QoS of the data packet (e.g., available resources may be determined according to QoS). If the DTE modem 230 determines that resources are available for the data packet, the DTE modem 230 may schedule and transmit the data packet to the ground station 135-a.

The DTE modem 230 may transmit the data packet to the ground station 135-a, for example using an RF component 255, an antenna unit 260, or both. The ground station 135-a may receive the data packet and retransmit the data packet to the ground-based server 130-a, for example via a network 125-a.

In some cases, the terminal 215 may determine whether the ground station 135-a is within an exclusion zone 138, as described with reference to FIG. 1. As described herein, an exclusion zone 138 for a data packet may be indicated by the policy engine (e.g., in accordance with a policy associated with the data packet). Additionally or alternatively, the exclusion zone 138 may be indicated within the metadata by the payload 210. An exclusion zone 138 may be sensor specific, location specific, etc., and may refer to an area or territory (e.g., a country, a non-secure location) in which transmitting data may be insecure or undesirable. If the terminal 215 determines that the ground station 135-a is within an exclusion zone (e.g., and that the delay to the next ground station outside the exclusion zone exceeds the latency metric), the terminal 215 may remove the data packet from the queue 214 associated with the DTE modem 230, and insert the data packet into the queue 213 associated with the L2G modem 225 for transmission via the first data path 220.

In some examples, the terminal 215 may receive a policy for data packets from ground based station, such as an on-ground policy control manager, which may be an example of a ground-based server 130 or ground station 135. For example, the policy control manager may transmit a policy or an update to a policy associated with an owner of a data packet via the first data path or the second data path. Additionally, the policy control manager may transmit, via the first data path or the second data path, a resource schedule indicating a schedule of available communication resources associated with one or more ground stations 135, an indication of a location of each of the ground stations, an indication of exclusion zones, or a combination thereof.

FIG. 3 illustrates an example of a process flow 300 that supports techniques for data routing between satellites and ground-based servers in accordance with aspects of the present disclosure. In some examples, process flow 300 may be implemented by aspects of the systems 100 and 200. For example, the process flow 300 may include operations performed by aspects of a satellite, such as a LEO satellite 110 having a terminal (e.g., a router, a terminal 215) coupled with an L2G modem 225 and a DTE modem 230, which may be examples of the corresponding devices as described with reference to FIGS. 1 and 2. In some examples, the terminal may access information associated with the satellite, such as positional information, velocity information, information indicating a time at which the satellite will be in range of a ground station, or a combination thereof. In the following description of the process flow 300, the operations may be performed in a different order than the order shown. Some operations may also be left out of the process flow 300, or other operations may be added to process flow 300.

The process flow 300 may illustrate a process to determine a data path to transmit a data packet 305 from a payload of the satellite to a ground-server in accordance with a policy. For example, the policy may indicate a latency metric (e.g., a duration associated with communicating the data packet from the satellite to the ground based server), a QoS metric associated with a priority of the data packet, or both. In some examples, the satellite or aspects thereof, such as terminal, router, or policy engine, may manage the policy, and may add metadata to the data packet indicating the latency metric, the QoS metric, or both. Accordingly, at 310, the terminal may receive the data packet from the payload and read the metadata (e.g., a header of the data packet) to determine the latency metric associated with the data packet, the QoS metric associated with the data packet, or both.

At 315, the terminal may determine whether the latency metric is less than a threshold. The threshold may correspond to a duration of time until the satellite is within range of ground station (e.g., a ground station which may allow a DTE link from the satellite to the ground-based server). Additionally or alternatively, the threshold may correspond to a larger value of the duration of time until the satellite is within range of a ground station and a duration of time associated with scheduling and preparing the data packet for transmission to the ground station. If the latency metric is less than the threshold, the terminal may, at 320, place the data packet in a queue associated with a first data path (e.g., a first data path 220), such as an indirect path via a GEO satellite.

At 325, the terminal may determine whether a quantity of available resources associated with the first data path (e.g., a quantity of available of resources of the L2G modem 225 for communicating with the GEO satellite) exceed a threshold. For example, the terminal may determine, by sending a request for resources in accordance with the QoS metric to the L2G modem, whether the quantity of available resources (e.g., the quantity of resources available for the QoS metric) is sufficient to transmit the data packet via the first data path. If the terminal determines that the quantity of available resources is sufficient for the data packet, the terminal may, at 330, schedule the data packet for transmission via the first data path, and the L2G modem may transmit the data packet to the ground-based server via the GEO satellite and a ground station in communication with the GEO satellite.

If the terminal determines that the quantity of available resources is not sufficient for the data packet, the terminal may store the data packet (e.g., in the queue associated with the L2G modem) for a duration. In some examples, the L2G modem may receive an updated schedule of available resources (e.g., from the GEO satellite, from the ground station, or both). Accordingly, if the updated resources are sufficient for the data packet (e.g., resources are available for the QoS metric), the L2G modem may transmit an indication to the terminal. In some cases, as part of storing the data packet for the duration, the terminal may, at 335, update (e.g., may increase) the QoS metric of the data packet. For example, if the latency metric reaches a second threshold, the terminal may, in accordance with the policy associated with the data packet, increase the QoS metric, such that the request for resources from the L2G modem may include the updated QoS metric, and thus a higher priority for receiving resources.

In some cases, at 315, the terminal may determine that the latency metric is greater than the threshold. In such cases, the terminal may determine to transmit the data packet to the ground-based server using a second data path (e.g., the second data path 222), such as a direct link or DTE link to the ground station. Accordingly, at 340, the terminal may place the data packet in a queue associated with the DTE modem.

In some examples, at 345, the terminal may determine whether the ground station associated with the second data path is within an exclusion zone. For example, the terminal may compare an identifier of the ground station with a catalogue of ground stations within exclusion zones (e.g., a catalogue included in a resource schedule received from a policy control manager, as described with reference to FIG. 2). If the terminal determines that the ground station is within an exclusion zone (e.g., and that the delay to the next ground station exceeds the latency metric), the terminal may remove the data packet from the queue associated with the second data path, and may place the data packet in the queue associated with the first data path for transmission via the first data path.

Alternatively, if the terminal determines that the ground station is not within an exclusion zone, the terminal may, at 350, schedule the data packet for transmission via the second data path, and the DTE modem may transmit the data packet to the ground station. The ground station may forward the data packet to the ground based server, for example using a network (e.g., a network 125).

FIG. 4 illustrates a block diagram 400 of a communication system 420 that supports techniques for data routing between satellites and ground-based servers in accordance with aspects of the present disclosure. The communication system 420 may be an example of aspects of a communication system as described with reference to FIGS. 1 through 3. For example, the communication system 420 may be an example of a terminal 215, an L2G modem 225, a DTE modem 230, or a combination thereof, as described with reference to FIG. 2. The communication system 420, or various components thereof, may be an example of means for performing various aspects of techniques for data routing between satellites and ground-based servers as described herein. For example, the communication system 420 may include a reception component 425, such as the antenna unit 245, the antenna unit 260, or both, a latency control component 430, which may be an example of the policy engine 217, a queuing component 435, which may be an example of the terminal 215, a resource acquisition component 440, which may be an example of the terminal 215, a transmission component 445, such as the antenna unit 245, the antenna unit 260, or both, a storage component 450, which may be an example of the policy engine 217, a policy control component 455, which may be an example of the policy engine 217, or any combination thereof. Each of these components may communicate, directly or indirectly, with one another.

The reception component 425 may be configured as or otherwise support a means for receiving, at a terminal of a first satellite of a plurality of first satellites, a data packet from a payload of the first satellite, the data packet comprising metadata indicating a latency metric associated with the data packet and a quality of service (QoS) metric associated with the data packet. The latency control component 430 may be configured as or otherwise support a means for determining whether the latency metric is less than a threshold, wherein the threshold is based at least in part on a first duration associated with the first satellite being in range of a ground station of a plurality of ground stations. The queuing component 435 may be configured as or otherwise support a means for queuing, based at least in part on determining that the latency metric is less than the threshold, the data packet for transmission via a first data path of a plurality of data paths from the first satellite to a ground-based server for the data packet, the first data path associated with an indirect link via one or more second satellites, wherein the plurality of data paths comprises the first data path and a second data path associated with a direct link to one or more of the plurality of ground stations.

In some examples, the resource acquisition component 440 may be configured as or otherwise support a means for determining, based at least in part on queuing the data packet, whether a quantity of available resources associated with the indirect link exceeds a second threshold, wherein the quantity of available resources is based at least in part on a quality of service (QOS) metric associated with the data packet and included in the metadata. In some examples, the transmission component 445 may be configured as or otherwise support a means for transmitting the data packet to the ground-based server via the first data path based at least in part on determining that the quantity of available resources exceeds the second threshold.

In some examples, the reception component 425 may be configured as or otherwise support a means for receiving, from a ground based station, a resource schedule of the quantity of available resources.

In some examples, the threshold comprises a function of the first duration and a second duration associated with queuing the data packet for transmission.

In some examples, the resource acquisition component 440 may be configured as or otherwise support a means for determining whether a quantity of available resources associated with the indirect link exceeds a second threshold, wherein the quantity of available resources is based at least in part on a quality of service (QOS) metric associated with the data packet and included in the metadata. In some examples, the storage component 450 may be configured as or otherwise support a means for storing the data packet for a duration of time based at least in part on determining that the quantity does not exceed the second threshold.

In some examples, the resource acquisition component 440 may be configured as or otherwise support a means for updating the QoS metric based at least in part on a policy stored at the terminal and updating the latency metric based on an elapsed time since the data packet was received. In some examples, the resource acquisition component 440 may be configured as or otherwise support a means for determining whether a second quantity of available resources associated with the indirect link exceeds the second threshold, wherein the second quantity of available resources is based at least in part on the updated QoS metric. In some examples, the transmission component 445 may be configured as or otherwise support a means for transmitting the data packet to the ground-based server via the first data path based at least in part on determining that the second quantity of available resources exceeds the second threshold.

In some examples, the reception component 425 may be configured as or otherwise support a means for receiving the policy from a ground-based station.

In some examples, the terminal comprises a policy engine configured to manage the policy.

In some examples, the reception component 425 may be configured as or otherwise support a means for receiving, at a terminal of a first satellite of a plurality of first satellites, a data packet from a payload of the first satellite, the data packet comprising metadata indicating a latency metric associated with the data packet and a quality of service (QOS) metric associated with the data packet. In some examples, the latency control component 430 may be configured as or otherwise support a means for determining whether the latency metric is less than a threshold, wherein the threshold is based at least in part on a first duration associated with the first satellite being in range of a ground station of a plurality of ground stations. In some examples, the queuing component 435 may be configured as or otherwise support a means for queuing, based at least in part on determining that the latency metric is not less than the threshold, the data packet for transmission via a second data path of a plurality of data paths from the first satellite to a ground-based server for the data packet, the second data path associated with a direct link to the ground station, wherein the plurality of data paths comprises the second data path and a first data path associated with an indirect link via one or more second satellites.

In some examples, the transmission component 445 may be configured as or otherwise support a means for transmitting, based at least in part on the queuing, the data packet to the ground-based server via the second data path.

In some examples, the policy control component 455 may be configured as or otherwise support a means for determining whether the ground station is within an exclusion zone. In some examples, the queuing component 435 may be configured as or otherwise support a means for queuing the data packet for transmission via the first data path based at least in part on determining that the ground station is within the exclusion zone. In some examples, the transmission component 445 may be configured as or otherwise support a means for transmitting the data packet to the ground-based server via the first data path.

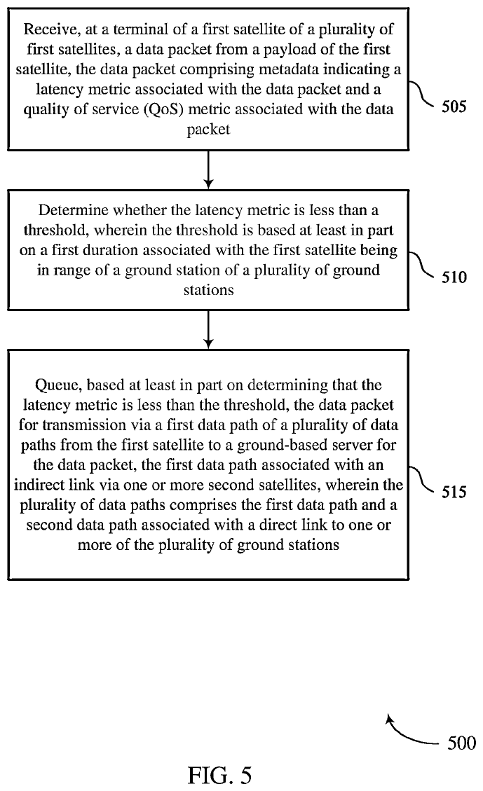

FIG. 5 illustrates a flowchart showing a method 500 that supports techniques for data routing between satellites and ground-based servers in accordance with aspects of the present disclosure. The operations of the method 500 may be implemented by a communication system or its components as described herein. For example, the operations of the method 500 may be performed by a communication system as described with reference to FIGS. 1 through 4. In some examples, a communication system may execute a set of instructions to control the functional elements of the communication system to perform the described functions. Additionally, or alternatively, the communication system may perform aspects of the described functions using special-purpose hardware.

At 505, the method may include receiving, at a terminal of a first satellite of a plurality of first satellites, a data packet from a payload of the first satellite, the data packet comprising metadata indicating a latency metric associated with the data packet and a quality of service (QOS) metric associated with the data packet. The operations of 505 may be performed in accordance with examples as disclosed herein. In some examples, aspects of the operations of 505 may be performed by a reception component 425 as described with reference to FIG. 4.

At 510, the method may include determining whether the latency metric is less than a threshold, wherein the threshold is based at least in part on a first duration associated with the first satellite being in range of a ground station of a plurality of ground stations. The operations of 510 may be performed in accordance with examples as disclosed herein. In some examples, aspects of the operations of 510 may be performed by a latency control component 430 as described with reference to FIG. 4.

At 515, the method may include queuing, based at least in part on determining that the latency metric is less than the threshold, the data packet for transmission via a first data path of a plurality of data paths from the first satellite to a ground-based server for the data packet, the first data path associated with an indirect link via one or more second satellites, wherein the plurality of data paths comprises the first data path and a second data path associated with a direct link to one or more of the plurality of ground stations. The operations of 515 may be performed in accordance with examples as disclosed herein. In some examples, aspects of the operations of 515 may be performed by a queuing component 435 as described with reference to FIG. 4.

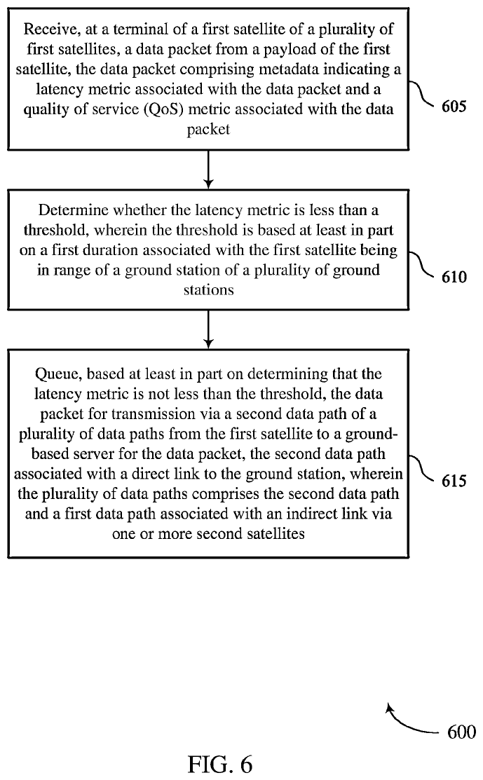

FIG. 6 illustrates a flowchart showing a method 600 that supports techniques for data routing between satellites and ground-based servers in accordance with aspects of the present disclosure. The operations of the method 600 may be implemented by a communication system or its components as described herein. For example, the operations of the method 600 may be performed by a communication system as described with reference to FIGS. 1 through 4. In some examples, a communication system may execute a set of instructions to control the functional elements of the communication system to perform the described functions. Additionally, or alternatively, the communication system may perform aspects of the described functions using special-purpose hardware.

At 605, the method may include receiving, at a terminal of a first satellite of a plurality of first satellites, a data packet from a payload of the first satellite, the data packet comprising metadata indicating a latency metric associated with the data packet and a quality of service (QOS) metric associated with the data packet. The operations of 605 may be performed in accordance with examples as disclosed herein. In some examples, aspects of the operations of 605 may be performed by a reception component 425 as described with reference to FIG. 4.

At 610, the method may include determining whether the latency metric is less than a threshold, wherein the threshold is based at least in part on a first duration associated with the first satellite being in range of a ground station of a plurality of ground stations. The operations of 610 may be performed in accordance with examples as disclosed herein. In some examples, aspects of the operations of 610 may be performed by a latency control component 430 as described with reference to FIG. 4.

At 615, the method may include queuing, based at least in part on determining that the latency metric is not less than the threshold, the data packet for transmission via a second data path of a plurality of data paths from the first satellite to a ground-based server for the data packet, the second data path associated with a direct link to the ground station, wherein the plurality of data paths comprises the second data path and a first data path associated with an indirect link via one or more second satellites. The operations of 615 may be performed in accordance with examples as disclosed herein. In some examples, aspects of the operations of 615 may be performed by a queuing component 435 as described with reference to FIG. 4.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer readable media includes both non transitory computer storage media and communication media including any medium that facilitates transfer of a computer program from one place to another. A non-transitory storage medium may be any available medium that can be accessed by a general purpose or special purpose computer. By way of example, and not limitation, non-transitory computer readable media may include RAM, ROM, electrically erasable programmable read-only memory (EEPROM), flash memory, compact disk read-only memory (CDROM) or other optical disk storage, magnetic disk storage or other magnetic storage devices, or any other non-transitory medium that can be used to carry or store desired program code means in the form of instructions or data structures and that can be accessed by a general purpose or special purpose computer, or a general purpose or special purpose processor. Also, any connection is properly termed a computer readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu ray disc where disks usually reproduce data magnetically, while discs reproduce data optically with lasers. Combinations of the above are also included within the scope of computer readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method, comprising:
receiving, at a terminal of a first satellite of a plurality of first satellites, a data packet from a payload of the first satellite, the data packet comprising metadata indicating a latency metric associated with the data packet and a quality of service metric associated with the data packet;
determining whether the latency metric is less than a threshold, wherein the threshold is based at least in part on a first duration associated with the first satellite being in range of a ground station of a plurality of ground stations; and
queuing, based at least in part on determining that the latency metric is less than the threshold, the data packet for transmission via a first data path of a plurality of data paths from the first satellite to a ground-based server for the data packet, the first data path associated with an indirect link via one or more second satellites, wherein the plurality of data paths comprises the first data path and a second data path associated with a direct link to one or more of the plurality of ground stations.

2. The method of claim 1, further comprising:
determining, based at least in part on queuing the data packet, whether a quantity of available resources associated with the indirect link exceeds a second threshold, wherein the quantity of available resources is based at least in part on the QoS metric associated with the data packet and included in the metadata; and
transmitting the data packet to the ground-based server via the first data path based at least in part on determining that the quantity of available resources exceeds the second threshold.

3. The method of claim 2, further comprising:
receiving, from a ground based station, a resource schedule of the quantity of available resources.

4. The method of claim 1, wherein the threshold comprises a function of the first duration and a second duration associated with queuing the data packet for transmission.

5. The method of claim 1, further comprising:
determining whether a quantity of available resources associated with the indirect link exceeds a second threshold, wherein the quantity of available resources is based at least in part on the QoS metric associated with the data packet and included in the metadata; and
storing the data packet for a duration of time based at least in part on determining that the quantity does not exceed the second threshold.

6. The method of claim 5, further comprising:
updating the QoS metric based at least in part on a policy stored at the terminal and updating the latency metric based on an elapsed time since the data packet was received;
determining whether a second quantity of available resources associated with the indirect link exceeds the second threshold, wherein the second quantity of available resources is based at least in part on the updated QoS metric; and
transmitting the data packet to the ground-based server via the first data path based at least in part on determining that the second quantity of available resources exceeds the second threshold.

7. The method of claim 6, further comprising:
receiving the policy from a ground-based station.

8. The method of claim 6, wherein the terminal comprises a policy engine configured to manage the policy.

9. A method, comprising:
receiving, at a terminal of a first satellite of a plurality of first satellites, a data packet from a payload of the first satellite, the data packet comprising metadata indicating a latency metric associated with the data packet and a quality of service metric associated with the data packet;
determining whether the latency metric is less than a threshold, wherein the threshold is based at least in part on a first duration associated with the first satellite being in range of a ground station of a plurality of ground stations; and
queuing, based at least in part on determining that the latency metric is not less than the threshold, the data packet for transmission via a second data path of a plurality of data paths from the first satellite to a ground-based server for the data packet, the second data path associated with a direct link to the ground station, wherein the plurality of data paths comprises the second data path and a first data path associated with an indirect link via one or more second satellites.

10. The method of claim 9, further comprising:
transmitting, based at least in part on the queuing, the data packet to the ground-based server via the second data path.

11. The method of claim 9, further comprising:
determining whether the ground station is within an exclusion zone;
queuing the data packet for transmission via the first data path based at least in part on determining that the ground station is within the exclusion zone; and
transmitting the data packet to the ground-based server via the first data path.

12. An apparatus, configured to:
receive, at a terminal of a first satellite of a plurality of first satellites, a data packet from a payload of the first satellite, the data packet comprising metadata indicating a latency metric associated with the data packet and a quality of service metric associated with the data packet;
determine whether the latency metric is less than a threshold, wherein the threshold is based at least in part on a first duration associated with the first satellite being in range of a ground station of a plurality of ground stations; and
queue, based at least in part on determining that the latency metric is less than the threshold, the data packet for transmission via a first data path of a plurality of data paths from the first satellite to a ground-based server for the data packet, the first data path associated with an indirect link via one or more second satellites, wherein the plurality of data paths comprises the first data path and a second data path associated with a direct link to one or more of the plurality of ground stations.

13. The apparatus of claim 12, further configured to:
determine, based at least in part on queuing the data packet, whether a quantity of available resources associated with the indirect link exceeds a second threshold, wherein the quantity of available resources is based at least in part on the QoS metric associated with the data packet and included in the metadata; and
transmit the data packet to the ground-based server via the first data path based at least in part on determining that the quantity of available resources exceeds the second threshold.

14. The apparatus of claim 13, further configured to:
receive, from a ground based station, a resource schedule of the quantity of available resources.

15. The apparatus of claim 12, wherein the threshold comprises a function of the first duration and a second duration associated with queuing the data packet for transmission.

16. The apparatus of claim 12, further configured to:
determine whether a quantity of available resources associated with the indirect link exceeds a second threshold, wherein the quantity of available resources is based at least in part on the QoS metric associated with the data packet and included in the metadata; and
store the data packet for a duration of time based at least in part on determining that the quantity does not exceed the second threshold.

17. The apparatus of claim 16, further configured to:
update the QoS metric based at least in part on a policy stored at the terminal and updating the latency metric based on an elapsed time since the data packet was received;
determine whether a second quantity of available resources associated with the indirect link exceeds the second threshold, wherein the second quantity of available resources is based at least in part on the updated QoS metric; and
transmit the data packet to the ground-based server via the first data path based at least in part on determining that the second quantity of available resources exceeds the second threshold.

18. The apparatus of claim 17, further configured to:
receive the policy from a ground-based station.

19. The apparatus of claim 17, wherein:
the terminal comprises a policy engine configured to manage the policy.
